(19) United States
(12) Patent Application Publication
(10) Pub. No.: US 2014/0253047 A1
(43) Pub. Date: Sep. 11, 2014

(54) ELECTRONIC DEVICE AND SYSTEM

(71) Applicant: Kabushiki Kaisha Toshiba, Tokyo (JP)

(72) Inventor: Yutaka Horie, Mitaka-shi (JP)

(73) Assignee: Kabushiki Kaisha Toshiba, Tokyo (JP)

(21) Appl. No.: 13/973,853

(22) Filed: Aug. 22, 2013

Related U.S. Application Data
(63) Continuation of application No. PCT/JP2013/056502, filed on Mar. 8, 2013.

(51) Int. Cl. H02J 7/00

(52) U.S. Cl. CPC H02J 7/0068
USPC 320/150

(57) ABSTRACT

According to one embodiment, an electronic device includes a battery, a power supply circuit, and a charging circuit. The power supply circuit supplies power to components in the device by using DC power from an AC power supply or DC power from the battery. The charging circuit charges the battery by using the DC power from the AC power supply. The charging circuit includes a charger IC that controls a charging current and a charging voltage which are output from the charging circuit to the battery. The charger IC includes a first input terminal for monitoring a temperature of the AC power supply, and performs control for reducing the charging current when the temperature of the AC power supply exceeds a first temperature during the charging of the battery.

### CROSS REFERENCE TO RELATED APPLICATIONS

This application is a Continuation Application of PCT Application No. PCT/JP2013/056502, filed Mar. 8, 2013, the entire contents of which are incorporated herein by reference.

### FIELD

Embodiments described herein relate generally to a battery-drivable electronic device and a system including the electronic device.

### BACKGROUND

In recent years, a variety of notebook type or laptop type portable personal computers have been developed. As power sources of such computers, batteries, AC power supplies (AC adapters), and the like are used.

Recently, power management technology for reducing power consumption of a system when it is detected that an AC adapter is in a high-temperature condition is also beginning to be developed.

However, in many cases, the conventional power management technology is realized using the control of so-called “firmware” which is software executed by a microcomputer. Therefore, there is a case where an excessive temperature rise of an AC adapter is caused by a response delay of a microcomputer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an external appearance of an electronic device according to an embodiment.

FIG. 2 is a diagram illustrating a detachable AC adapter that is mountable into the electronic device according to the embodiment.

FIG. 3 is a diagram illustrating a relationship between an external power terminal of the electronic device according to the embodiment and the detachable AC adapter disposed outside the electronic device.

FIG. 4 is a block diagram illustrating a system configuration of the electronic device according to the embodiment.

FIG. 5 is a block diagram illustrating a configuration of a power subsystem of the electronic device according to the embodiment.

FIG. 6 is a circuit diagram illustrating a configuration of a charging circuit that is provided inside the electronic device according to the embodiment and includes a charger IC.

FIG. 7 is a diagram explaining an operation of the charger IC of FIG. 6.

FIG. 8 is a diagram explaining an operation of a temperature feedback loop of the charger IC of FIG. 6.

FIG. 9 is a block diagram illustrating a configuration of the power subsystem of the electronic device according to the embodiment.

### DETAILED DESCRIPTION

Various embodiments will be described hereinafter with reference to the accompanying drawings.

In general, according to one embodiment, an electronic device includes a battery, a power supply circuit, and a charging circuit. The power supply circuit supplies power to components in the electronic device by using DC power from an AC power supply or DC power from the battery. The charging circuit charges the battery by using the DC power from the AC power supply. The charging circuit includes a charger IC that controls a charging current and a charging voltage which are output from the charging circuit to the battery. The charger IC includes a first input terminal for monitoring a temperature of the AC power supply, and is configured to perform control for reducing the charging current when the temperature of the AC power supply exceeds a first temperature during the charging of the battery.

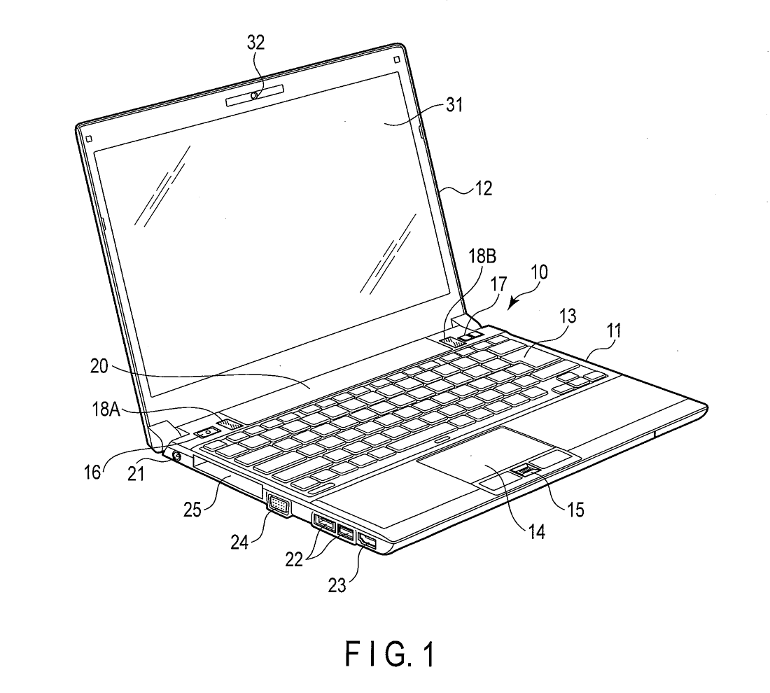

First, a configuration of an electronic device according to an embodiment will be described below with reference to FIG. 1. The electronic device may be implemented as, for example, a notebook type portable personal computer, a tablet terminal, or other various portable electronic devices. Hereinafter, a case where the electronic device is implemented as a notebook type portable personal computer 10 will be assumed.

FIG. 1 is a perspective view viewed from the front side of the computer 10 in a state in which a display unit is opened. The computer 10 is configured to receive power from the battery 20. The computer 10 is configured to supply power (operating power) to components inside the computer 10 by using power from the battery 20 or power from an AC power supply (AC adapter).

The computer 10 includes a computer main body 11 and a display unit 12. The display unit 12 is provided with a display device such as a liquid crystal display (LCD) 31. Furthermore, a camera (web camera) 32 is disposed in an upper portion of the display unit 12.

The display unit 12 is attached to the computer main body 11 rotatably between an open position at which a top surface of the computer main body 11 is exposed and a closed position at which the top surface of the computer main body 11 is covered with the display unit 12. The computer main body 11 includes a thin box-like housing and, on the top surface thereof, a keyboard 13, a touch pad 14, a fingerprint sensor 15, a power switch 16 configured to turn on/off the power of the computer 10, a plurality of function buttons 17, and speakers 18A and 18B are disposed.

Also, a power connector (DC power input terminal) 21 is provided in the computer main body 11. The power connector 21 is provided on a side of the computer main body 11, for example, a left side thereof. An AC power supply is removably connected to the power connector 21. As the AC power supply, an AC adapter may be used. The AC adapter is an AC power supply that converts commercial power (AC power) into DC power.

In the present embodiment, as the above-described AC power supply, a detachable AC adapter removably mounted into the computer 10 may be used. Rated current capacity required to the AC adapter for computer is relatively large. Therefore, in the past, it has been difficult to miniaturize the AC adapter for computer.

In recent years, the development of a high-speed switching element using a GaN chip has been in progress. The use of the high-speed switching element made of GaN makes it possible to miniaturize an inductor and a capacitor inside the AC adapter. By miniaturizing the inductor and the capacitor, a small-size AC adapter including sufficient rated current capacity may be realized.

In the present embodiment, as the above-described detachable AC adapter, a small-size AC adapter using a high-speed switching element made of GaN may be used. The detachable AC adapter may improve the portability of the computer 10. This is because a user may carry the computer 10 in a state in which the detachable AC adapter is attached to the computer 10, reducing the number of luggage to be carried. Furthermore, if necessary, the user may remove the detachable AC adapter from the computer 10 and carry the computer 10 alone. In this case, the weight of the computer 10 is reduced as much as that of the detachable AC adapter, improving the portability of the computer 10. Furthermore, the detachable AC adapter may also contribute to efficient use of a work space on a desk. Moreover, like a general AC adapter, the detachable AC adapter may be connected to the power connector (DC power input terminal) 21 through a power cable. In this case, it is possible to suppress a temperature rise in the housing of the computer 10 due to heat generation of the detachable AC adapter.

The detachable AC adapter may be removably mounted on an AC adapter mounting portion 25 of the computer 10. The AC adapter mounting portion 25 is implemented as, for example, an AC adapter slot into which the entire detachable AC adapter may be inserted. The AC adapter mounting portion 25 is provided on a side of the computer main body 11, for example, a left side thereof. The AC adapter mounting portion 25 is disposed, for example, under the keyboard 13. The AC adapter mounting portion 25 includes an opening on the left side of the computer main body 11, and a space extending from the opening toward a central portion of the computer main body 11. The space has a size enough to receive the detachable AC adapter. Also, instead of using the detachable AC adapter, an AC adapter built in the computer 10 (internal AC power supply) may be used.

The battery 20 is removably mounted on, for example, a rear portion of the computer main body 11. The battery 20 may be a battery built in the computer 10.

The computer 10 is driven by the power from the AC power supply (for example, the detachable AC adapter) or the power from the battery 20. When the detachable AC adapter is mounted on the AC adapter mounting portion 25, or when the detachable AC adapter is connected to the power connector 21 through the power cable, the computer 10 is driven by the power from the detachable AC adapter. Also, the power from the detachable AC adapter is also used to charge the battery 20. During a period of time when the detachable AC adapter is not electrically connected to the computer 10, the computer 10 is driven by the power from the battery 20.

Furthermore, the computer main body 11 is provided with a plurality of USB ports 22, a high-definition multimedia interface (HDMI) output terminal 23, and an RGB port 24.

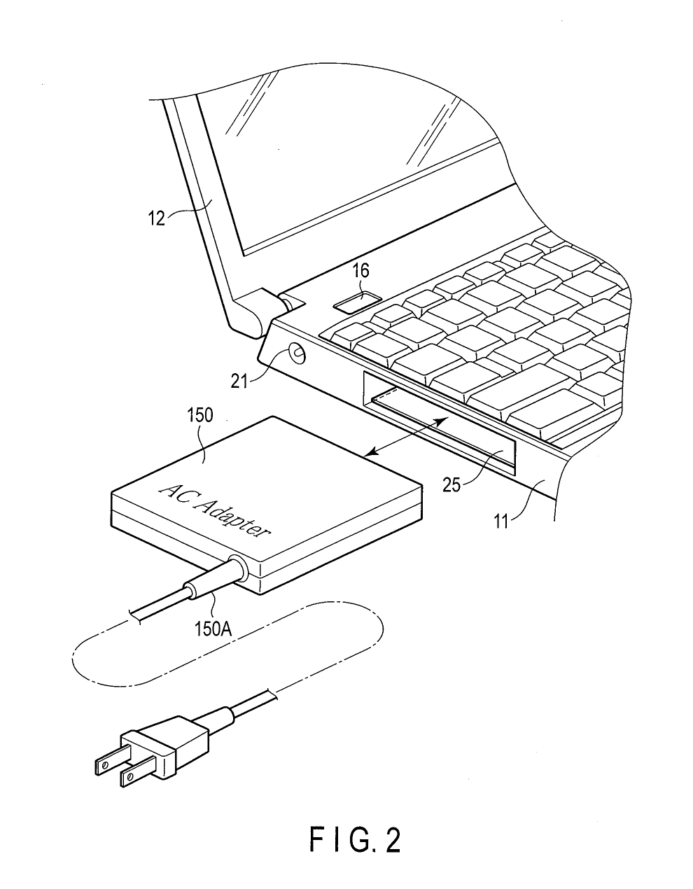

FIG. 2 illustrates a detachable AC adapter 150. As illustrated in FIG. 2, the detachable AC adapter 150 includes a housing including a slim box shape. A power cable 150A is derived from the front side of the housing of the detachable AC adapter 150. A power plug is attached to a leading end of the power cable 150A. Also, the power cable 150A may be configured to be removably connected to a power connector of the detachable AC adapter 150.

A receiving space of the AC adapter mounting portion 25 has a size enough to receive the entire detachable AC adapter 150, and the detachable AC adapter 150 is mounted in the AC adapter mounting portion 25 such that the front surface thereof is flush with the left side of the computer main body 11. A connector is provided on a rear side of the housing of the detachable AC adapter 150. When the detachable AC adapter 150 is mounted in the AC adapter mounting portion 25, the connector of the detachable AC adapter 150 is electrically connected to a power connector inside the AC adapter mounting portion 25.

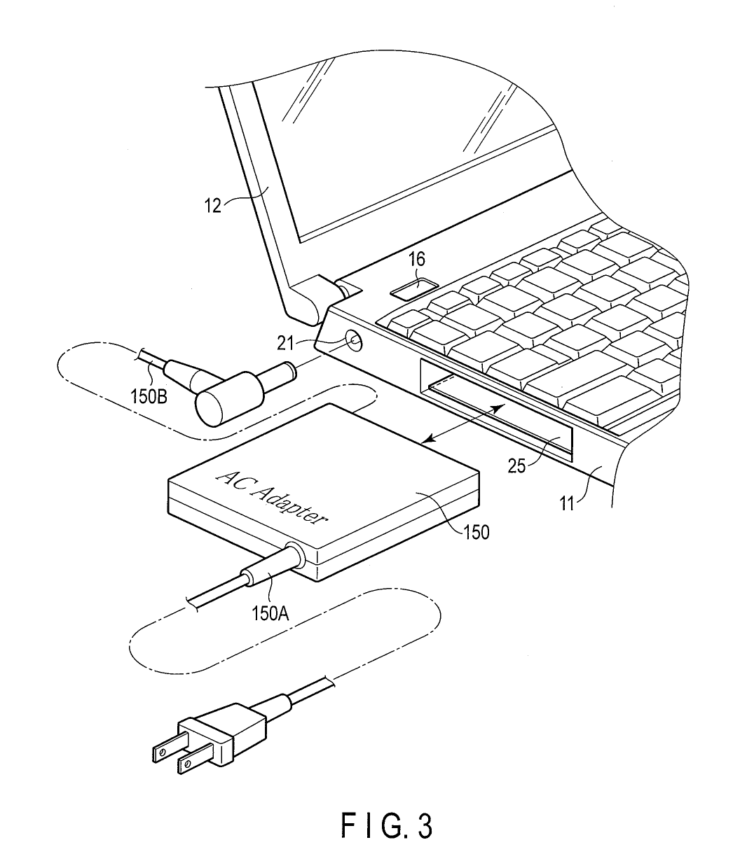

FIG. 3 illustrates a case where the detachable AC adapter 150 is used as an external AC power supply. A power cable 150B for DC power output may be connected to the detachable AC adapter 150. A plug for DC power output is attached to the leading end of the power cable 150B. Therefore, by connecting the plug for DC power output to the power terminal 21 of the computer 10, the detachable AC adapter 150 may be used as the external AC power supply.

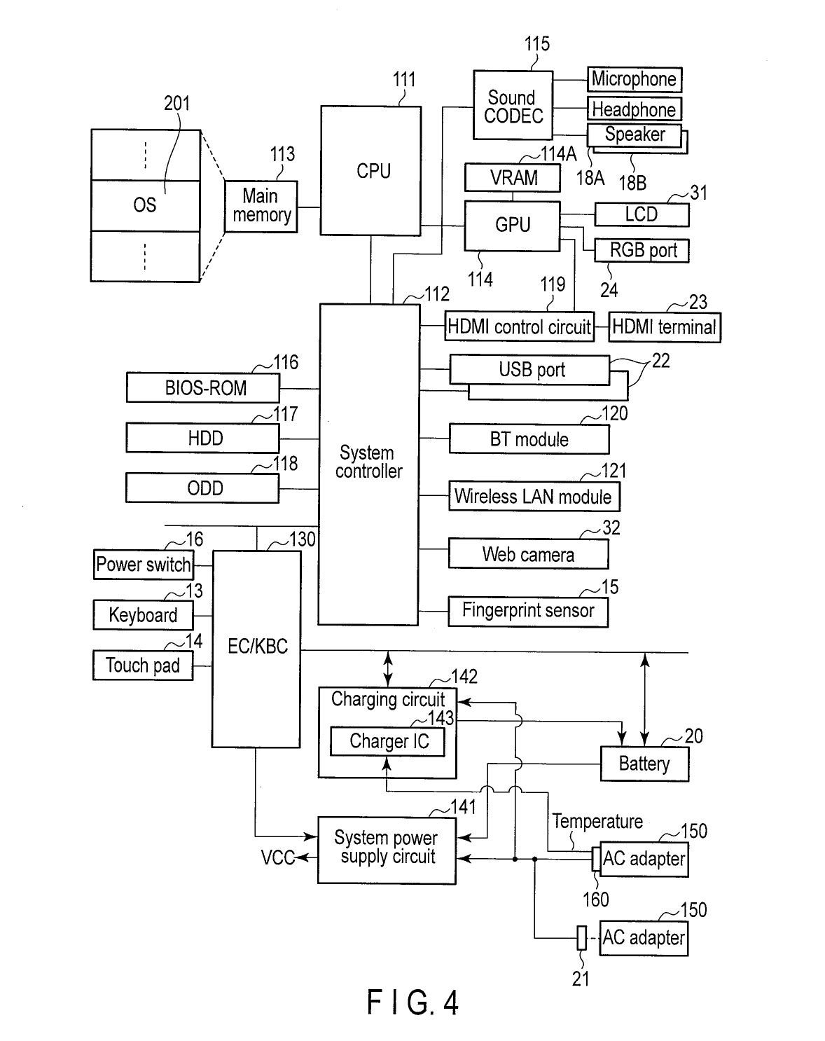

FIG. 4 illustrates a system configuration of the computer 10. The computer 10 includes a CPU 111, a system controller 112, a main memory 113, a graphics processing unit (GPU) 114, a sound codec 115, a BIOS-ROM 116, a hard disk drive (HDD) 117, an optical disk drive (ODD) 118, a BT (Bluetooth™) module 120, a wireless LAN module 121, an embedded controller/keyboard controller IC (EC/KBC) 130, a system power supply circuit 141, and a charging circuit 142.

The CPU 111 is a processor that controls an operation of each component of the personal computer 10. The CPU 111 executes various programs that are loaded from the HDD 117 on the main memory 113. The programs include an operating system (OS) 201 and various application programs.

The CPU 111 also executes the basic input/output system (BIOS) stored in the BIOS-ROM 116 being a nonvolatile memory. The BIOS is a system program for hardware control.

The GPU 114 is a display controller that controls the LCD 31 used as a display monitor of the personal computer 10. The GPU 114 generates a display signal (LVDS signal) to be supplied to the LCD 31 from display data stored in a video memory (VRAM) 114A. Furthermore, the GPU 114 may generate an analog RGB signal and an HDMI video signal from the display data. The analog RGB signal is supplied to an external display through the RGB port 24. The HDMI output terminal 23 may transmit an HDMI video signal (uncompressed digital video signal) and a digital audio signal to the external display through a cable. The HDMI control circuit 119 is an interface configured to transmit the HDMI video signal and the digital audio signal to the external device through the HDMI output terminal 23.

The system controller 112 is a bridge device that connects the CPU 111 and each component. The system controller 112 is embedded with a serial ATA controller configured to control the hard disk drive (HDD) 117 and the optical disk drive (ODD) 118. Also, devices such as the USB port 22, the BT module 120, the wireless LAN module 121, the web camera 32, and the fingerprint sensor 15 are connected to the system controller 112.

The EC/KBC 130 is a power management controller configured to perform power management of the computer 10. For example, the EC/KBC 130 is implemented as a one-chip microcomputer embedded with a keyboard controller that controls the keyboard (KB) 13 and the touch pad 14, or the like. The EC/KBC 130 has a function of turning on and off the power of the computer 10 according to a user's manipulation of the power switch 16. The power on/off control of the computer 10 is performed by a co-operation of the EC/KBC 130 and the system power supply circuit 141.

The system power supply circuit 141 is a power supply circuit configured to supply the power (operating power Vcc) to each component in the computer 10 by using the power (DC power) from the battery 20 or the power (DC power) from the detachable AC adapter 150. The power input terminal of the system power supply circuit 141 is connected to both the power connector 21 and the power connector 160 inside the AC adapter mounting portion 25. Therefore, even in either of the case where the detachable AC adapter 150 is connected to the power terminal 21 through the power cable and the case where the detachable AC adapter 150 is mounted in the AC adapter mounting portion 25, the system power supply circuit 141 may receive the power (DC power) from the detachable AC adapter 150.

When an ON signal transmitted from the EC/KBC 130 is received, the system power supply circuit 141 supplies the operating power to each component in the computer 10. Also, when an OFF signal transmitted from the EC/KBC 130 is received, the system power supply circuit 141 stop supplying the operating power to each component.

The EC/KBC 130 may communicate with each of the charging circuit 142 and the battery 20 through a serial bus. The charging circuit 142 is a circuit that charges the battery 20 by using the DC power from the detachable AC adapter 150. The charging circuit 142 includes a charger IC 143 configured to control a charging current and a charging voltage which are output from the charging circuit 142 to the battery 20. The charging current is a regulated output current of the charging circuit 142 and is used for charging the battery 20. The charging voltage is a regulated output voltage of the charging circuit 142 and is also referred to as a battery voltage.

The EC/KBC 130, the system power supply circuit 141, the charging circuit 142, and the charger IC 143 are operated even during a period of time when the power of the computer 10 is turned off.

Incidentally, when the detachable AC adapter 150 is in a state of being mounted in the AC adapter mounting portion 25, an area of a contact region between the detachable AC adapter 150 and outside air is reduced. Therefore, since heat dissipation of the detachable AC adapter 150 does not proceed, it is likely that the temperature of the housing of the computer main body 11 will be raised by heat generation of the detachable AC adapter 150.

As described above, the power from the detachable AC adapter 150 is used for not only driving the system load (system components) but also charging the battery 20. Therefore, when the charging of the battery 20 is started, much current is drawn from the detachable AC adapter 150. Hence, the temperature of the detachable AC adapter 150 easily rises. The heat generation of the detachable AC adapter 150 raises the temperature of the housing of the computer main body 11, which may cause a risk of low-temperature burn.

In the present embodiment, the charger IC 143 is configured to include a feedback loop (temperature feedback loop) that automatically reduces the charging current according to the temperature of the detachable AC adapter 150. That is, the charger IC 143 includes an input terminal (temperature monitoring pin) for monitoring the temperature of the detachable AC adapter 150, and performs control for reducing the charging current when the temperature of the detachable AC adapter 150 exceeds a threshold temperature during the charging of the battery 20. Since this may suppress the heat generation of the detachable AC adapter 150, it is possible to reduce a risk of low-temperature burn caused by the temperature rise in the housing of the computer main body 11.

It may be used a configuration that EC/KBC 130 monitors the temperature of the detachable AC adapter 150 and the firmware of the EC/KBC 130 instructs the charging circuit 142 or the charger 143 to reduce the charging current when the temperature of the detachable AC adapter 150 reaches the threshold temperature. However, when using this configuration, it is likely that the temperature of the detachable AC adapter 150 will exceed a temperature rating by response delay the EC/KBC 130 or hang-up of the EC/KBC 130. If the control of the charging current by the firmware is early started by setting the threshold temperature to be low, the temperature of the detachable AC adapter 150 may be prevented from exceeding the temperature rating. However, in this case, even though the temperature of the detachable AC adapter 150 is within an allowable range, the charging current is reduced, that is, the charging current is excessively limited. Hence, it is likely that time necessary for charging the battery will be lengthened. In the present embodiment, since the charger IC 143 itself has the above-described temperature feedback loop, the control of automatically reducing the charging current may be rapidly performed. During a period of time when the temperature of the detachable AC adapter 150 is higher than the threshold temperature, the operation of charging the battery 20 is continued and the battery 20 is charged with the reduced charging current. During the charging of the battery 20, when the temperature of the detachable AC adapter 150 is reduced to below the above-described threshold temperature, or is reduced to below another threshold temperature lower than the above-described threshold temperature, the charging current of the battery 20 is returned to the original value.

Therefore, the present embodiment can prevent the temperature of the detachable AC adapter 150 from exceeding the rated temperature, without excessive charging current limitation.

Also, the charger IC 143 may be configured to enable the above-described control of reducing the charging current only when the detachable AC adapter 150 is mounted on the computer 10, and to disable the above-described control of reducing the charging current only when the detachable AC adapter 150 is connected to the power connector 21 of the computer 10 through the power cable. This configuration may be easily implemented by electrically connecting the temperature monitoring pin of the IC 143 to only the temperature terminal inside the power connector 160.

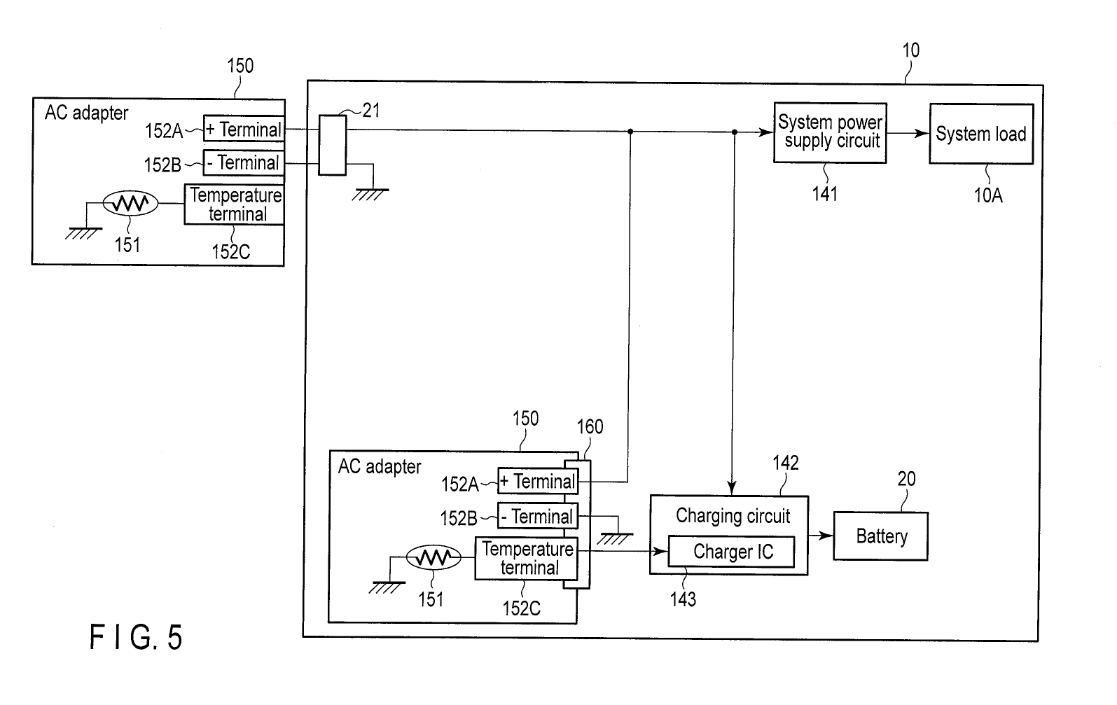

FIG. 5 illustrates a configuration of a power subsystem of the computer 10.

The detachable AC adapter 150 includes a temperature sensor 151. The temperature sensor 151 detects the temperature inside the detachable AC adapter 150. The temperature sensor 151 may be implemented by a thermistor. The detachable AC adapter 150 includes a positive (+) terminal 152A, a negative (−) terminal 152B, and a temperature terminal 152C.

When the detachable AC adapter 150 is connected to the power connector 21 of the computer 10 through the power cable, the positive (+) terminal 152A and the negative (−) terminal 152B of the detachable AC adapter 150 are connected to the power connector 21 through the power cable. The power cable does not include a signal line connected to the temperature terminal 152C. Therefore, the temperature terminal 152C is not connected to the power connector 21. DC power from the positive (+) terminal 152A of the detachable AC adapter 150 is supplied to the above-described system power supply circuit 141 through the power connector 21. The system power supply circuit 141 supplies the power to the system load 10A. The system load 10A is each component inside the computer 10.

The power connector 160 inside the AC adapter mounting portion 25 includes three terminals electrically connected to, respectively, the positive (+) terminal 152A, the negative (−) terminal 152B, and the temperature terminal 152C of the detachable AC adapter 150. When the AC adapter 150 is mounted in the AC adapter mounting portion 25 of the computer 10, the DC power from the positive (+) terminal 152A of the detachable AC adapter 150 is supplied to the above-described system power supply circuit 141 through the power connector 160. Also, the temperature monitoring pin of the charger IC 143 is connected to the temperature terminal 152C of the detachable AC adapter 150 through the power connector 160 of the AC adapter mounting portion 25 to receive the signal representing the temperature of the detachable AC adapter 150 from the detachable AC adapter 150.

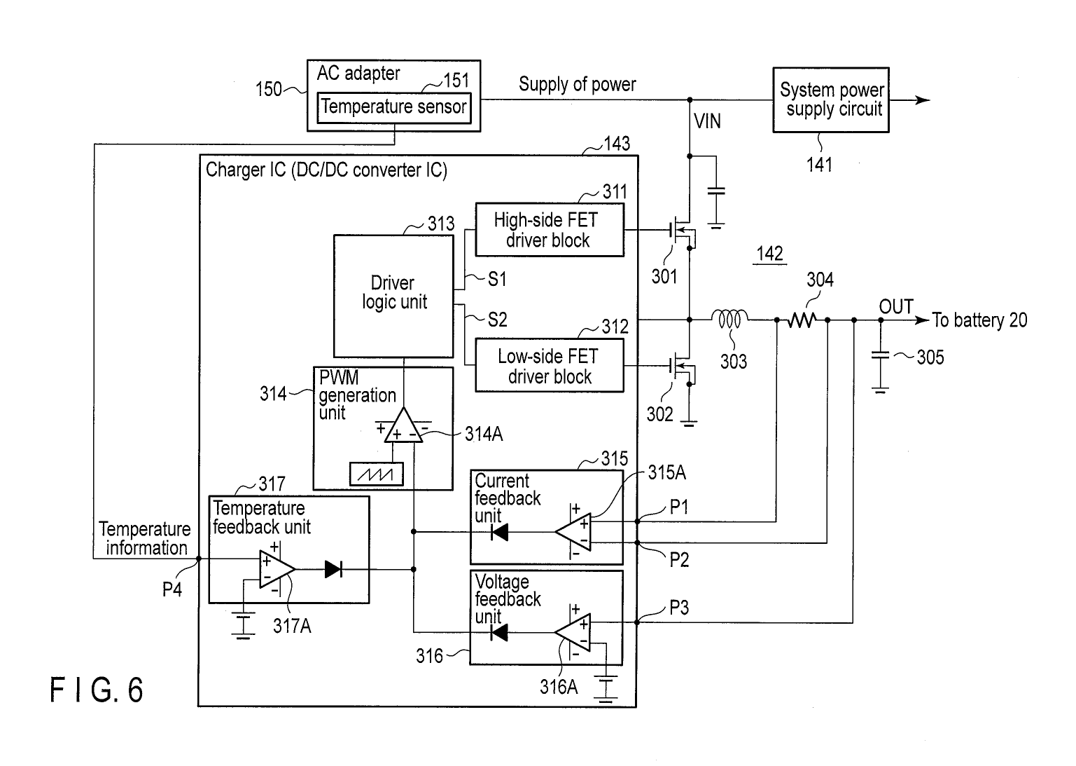

FIG. 6 illustrates a configuration of the charging circuit 142 including the charger IC 143.

The charging circuit 142 is implemented as, for example, a synchronous rectification type switching power supply. A high-side FET 301 and a low-side FET 302 are connected in series between a power input terminal VIN connected to the positive (+) terminal 152A of the detachable AC adapter 150 and a ground terminal. An inductor 303 and a capacitor 305 constitute a smoothing circuit. A resistor 304 for current sense is inserted between the inductor 303 and the capacitor 305.

The charger IC 143 functions as a DC/DC converter configured to control the charging current and the charging voltage by controlling on-duty ratio of the high-side FET 301 being a switching element.

The charger IC 143 includes a high-side FET driver block 311, a low-side FET driver block 312, a driver logic unit 313, a pulse width modulation (PWM) generation unit 314, a current feedback unit 315, a voltage feedback unit 316, and a temperature feedback unit 317. The high-side FET driver block 311 controls the switching of the high-side FET 301 according to a switch control signal S1 from the driver logic unit 313. The low-side FET driver block 312 controls the switching of the low-side FET 302 according to a switch control signal S2 from the driver logic unit 313. The switch control signal S2 is a complementary signal obtained by inverting the switch control signal S1. The low-side FET 302 maintains an on state while the high-side FET 301 is in an off state. Therefore, the low-side FET 302 functions as a synchronous rectifier (synchronous rectifying diode).

The driver logic unit 313 generates the above-described switch control signals S1 and S2 according to the PWM signal from the PWM generation unit 314. The PWM generation unit 314 includes a comparator 314A. The comparator 314A compares a triangular-wave reference signal with a control signal, and generates a PWM signal whose on-duty duration is duration where a voltage of the triangular-wave is higher than a voltage of the control signal. Therefore, a length of the on duty duration of the PWM signal, that is, a ratio (on duty ratio) of the on duration of the high-side FET 301 to the switching period, varies according to the voltage of the control signal. In order to generate the control signal, the current feedback unit 315, the voltage feedback unit 316, and the temperature feedback unit 317 are used.

The current feedback unit 315 includes two input terminals P1 and P2 for monitoring the charging current. The input terminal P1 is connected to a positive-side terminal of the current-sense resistor 304, and the input terminal P2 is connected to a negative-side terminal of the current-sense resistor 304. An error amplifier 315A inside the current feedback unit 315 controls the voltage of the above-described control signal such that the charging current becomes constant. The current feedback unit 315 and the PWM generation unit 314 function as a current feedback loop that monitors the charging current and controls the switching of the switching element (high-side FET 301) according to the charging current. When this current feedback loop is dominant over other feedback loops, the control of the charging current is performed for constant current charging at the constant current by the current feedback loop.

The voltage feedback unit 316 includes an input terminal P3 for monitoring the charging voltage (battery voltage). The input terminal P3 is connected to a node between the current-sense resistor 304 and the capacitor 305. An error amplifier 316A inside the voltage feedback unit 316 controls the voltage of the above-described control signal such that the charging voltage (battery voltage) is matched with a reference voltage. The voltage feedback unit 316 and the PWM generation unit 314 function as a voltage feedback loop that monitors the charging voltage (battery voltage) and controls the switching of the switching element (high-side FET 301) according to the charging voltage (battery voltage). When this voltage feedback loop is dominant over other feedback loops, the control of the charging voltage (battery voltage) is performed for constant voltage charging at the constant voltage by the voltage feedback loop. In other words, the charging current is controlled such that the regulated charging voltage (battery voltage) is obtained.

The temperature feedback unit 317 includes an input terminal P4 for monitoring the temperature of the detachable AC adapter 150. The input terminal P4 is connected to the temperature terminal 152C of the detachable AC adapter 150 through the AC adapter mounting portion 25. An error amplifier 317A inside the temperature feedback unit 317 controls the voltage of the control signal such that the charging current is reduced when the temperature of the detachable AC adapter 150 exceeds the threshold temperature. The temperature feedback unit 317 and the PWM generation unit 314 function as a temperature feedback loop that performs control for reducing the charging current being currently used in the constant current charging or the constant voltage charging when the temperature of the detachable AC adapter 150 exceeds the threshold temperature. During a period of time when the temperature of the detachable AC adapter 150 exceeds the threshold temperature, the temperature feedback loop is dominant over other feedback loops. For example, during the period of time when the temperature exceeds the threshold temperature, the output voltage of the temperature feedback unit 317 may be set to be higher than the output voltage ranges of other feedback units 315 and 316.

A case where the temperature of the detachable AC adapter 150 is equal to or lower than the threshold temperature will be assumed. In this case, the output voltage of the temperature feedback unit 317 is almost zero. Also, until the charging voltage (battery voltage) reaches a certain voltage, the output voltage of the voltage feedback unit 316 is also almost zero. Therefore, until the charging voltage (battery voltage) reaches the certain voltage, the control signal is controlled by only the output voltage of the current feedback unit 315. Therefore, the charger IC 143 controls the switching of the high-side FET by using the current feedback unit 315 such that the charging current becomes constant, and charges the battery 20 in a constant current charging mode.

A feedback unit for controlling the control signal transitions from the current feedback unit 315 to the voltage feedback unit 316 when the charging voltage (battery voltage) reaches the certain voltage. For example, the output voltage of the voltage feedback unit 316 may be set to be higher than the output voltage range of the current feedback unit 315. Therefore, after the charging voltage (battery voltage) reaches the certain voltage, the control signal may be controlled by only the output voltage of the voltage feedback unit 316.

Next, a case where the temperature of the detachable AC adapter 150 exceeds the threshold temperature will be assumed. When the temperature of the detachable AC adapter 150 exceeds the threshold temperature, the voltage of the control signal is raised by the output voltage of the temperature feedback unit 317. Therefore, the on duty ratio of the high-side FET 301 is lowered, and the charging current is reduced.

As described above, in the present embodiment, when the temperature of the detachable AC adapter 150 exceeds the threshold temperature, the current supplied to the system load 10A is not limited, but the charging current of the battery 20 is reduced. Therefore, the temperature rise in the detachable AC adapter 150 may be suppressed without affecting the operation of the system.

Also, when the temperature of the detachable AC adapter 150 exceeds a first threshold temperature, the charger IC 143 starts the control of reducing the charging current of the battery 20. When the temperature of the detachable AC adapter 150 exceeds a second threshold temperature higher than the first threshold temperature, the EC/KBC 130 may start processing of lowering the operating speed of the CPU 111 or other devices.

Also, the connection relationship between the feedback units 315 to 317 and the PWM generation unit 314 described above with reference to FIG. 6 is exemplary. It is possible to use an arbitrary configuration that may reduce the charging current by automatically lowering the on duty ratio of the high-side FET 301 when the temperature of the detachable AC adapter 150 exceeds the threshold temperature Th during the constant current charging or the constant voltage charging.

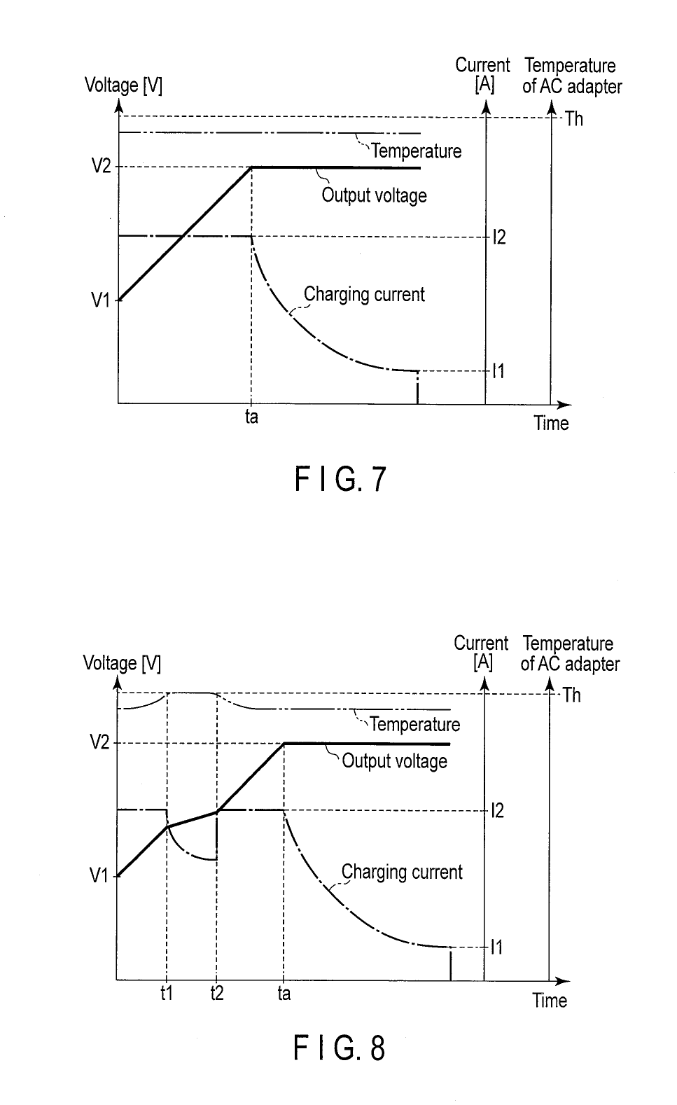

FIG. 7 illustrates the operation of the charger IC 143 of FIG. 6.

Herein, a case where the temperature of the detachable AC adapter 150 is equal to or lower than the threshold temperature Th will be assumed. The charger IC 143 charges the battery 20 with a certain constant charging current (I2) by using the current feedback loop configured to monitor and control the charging current (constant current charging). When the charging voltage (output voltage) reaches a certain threshold voltage (V2) (timing to of FIG. 7), the charger IC 143 charges the battery 20 with a certain constant voltage (V2) by using the voltage feedback loop configured to monitor and control the charging voltage (constant voltage charging). When the battery 20 becomes a fully charged state, for example, when the charging current is lowered to the charging stop current, the charging of the battery 20 is ended.

FIG. 8 illustrates the operation of the temperature feedback loop of the charger IC 143.

Herein, a case where the temperature of the detachable AC adapter 150 exceeds the threshold temperature Th during the constant current charging will be assumed. The charger IC 143 charges the battery 20 with a certain constant charging current (I2) by using the current feedback loop configured to monitor and control the charging current (constant current charging). When the temperature of the detachable AC adapter 150 exceeds the threshold temperature Th (timing t1 of FIG. 8), the charging current is reduced. After the charging current is reduced, when the temperature of the detachable AC adapter 150 is lowered to below the threshold temperature Th (timing t2 of FIG. 8), the control for reducing the charging current is stopped, and the charging current is returned to the original charging current (I2).

Also, although the case where the temperature of the detachable AC adapter 150 exceeds the threshold temperature Th during the constant current charging has been exemplified, the control for reducing the charging current of being used during the constant voltage charging is also performed in the case where the temperature of the detachable AC adapter 150 exceeds the threshold temperature Th during the constant voltage charging. When the temperature of the detachable AC adapter 150 is lowered to below the threshold voltage Th, the control for reducing the charging current is stopped, and the charging current is returned to the regulated original charging current.

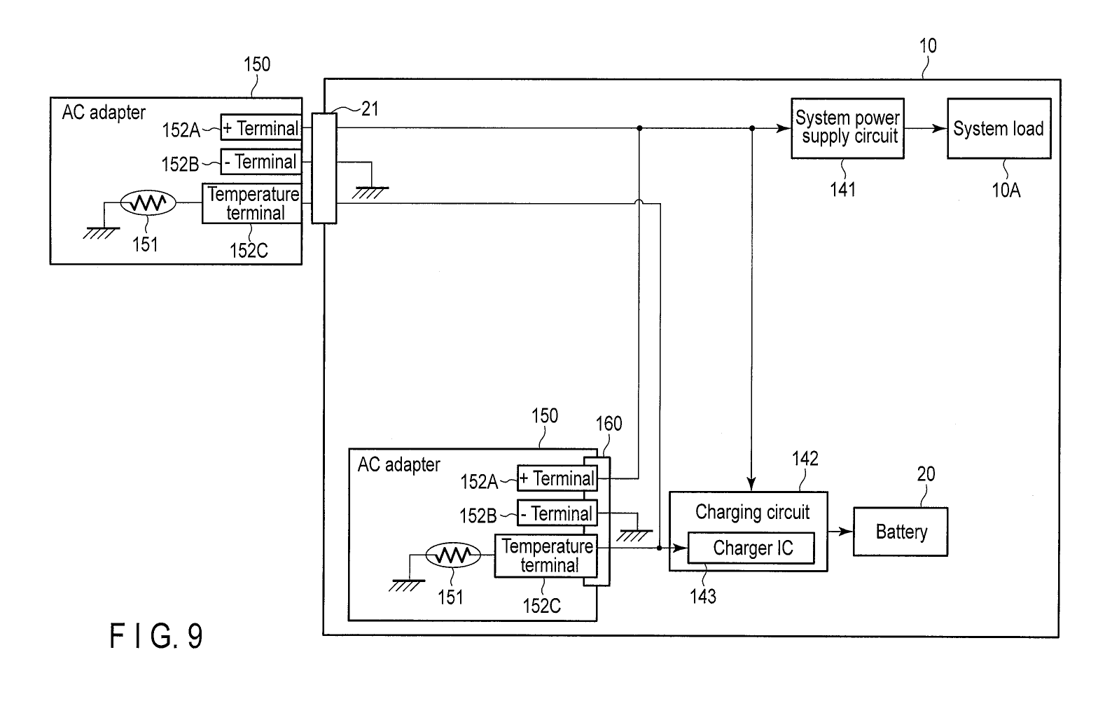

FIG. 9 illustrates another configuration of the power subsystem of the computer 10.

In FIG. 9, the charger IC 143 is connected to the temperature terminal 152C of the detachable AC adapter 150 in the case where the detachable AC adapter 150 is connected to the power connector 21 through the power cable as well as the case where the detachable AC adapter 150 is inserted into the AC adapter mounting portion 25. Therefore, the above-described temperature feedback loop may be functioned in the case where the detachable AC adapter 150 is connected to the power connector 21 through the power cable as well as the case where the detachable AC adapter 150 is inserted into the AC adapter mounting portion 25.

As described above, according to the present embodiment, the charger IC 143 includes the input terminal P4 for monitoring the temperature of the detachable AC adapter 150, and performs control for reducing the charging current when the temperature of the detachable AC adapter 150 exceeds the threshold temperature during the charging the battery 20. Therefore, the temperature rise in the detachable AC adapter 150 may be suppressed.

Also, the temperature feedback loop of the charger IC 143 may be applied to the detachable AC adapter 150, may be applied to the conventional external AC adapter, and may also be applied to the internal AC adapter.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a battery;
a power supply circuit configured to supply power to components in the electronic device by using DC power from an AC power supply or DC power from the battery; and
a charging circuit configured to charge the battery by using the DC power from the AC power supply, the charging circuit comprising a charger IC configured to control a charging current and a charging voltage which are output from the charging circuit to the battery,
wherein the charger IC includes a first input terminal for monitoring a temperature of the AC power supply, and is configured to perform control for reducing the charging current when the temperature of the AC power supply exceeds a first temperature during the charging of the battery.

2. The electronic device of claim 1, wherein the AC power supply is an AC adapter removably mounted in an AC power supply mounting portion of the electronic device, and the first input terminal is connected to the AC power supply through the AC power supply mounting portion to receive a signal representing the temperature of the AC power supply from the AC power supply.

3. The electronic device of claim 1, wherein the AC power supply is an AC adapter removably mounted in an AC power supply mounting portion of the electronic device, and
the charger IC is configured to enable the control for reducing the charging current when the AC power supply is mounted in the AC power supply mounting portion of the electronic device, and disable the control for reducing the charging current when the AC power supply is connected to a DC power input terminal of the electronic device through a power cable.

4. The electronic device of claim 1, wherein the charger IC includes a second input terminal for monitoring the charging current, and a third input terminal for monitoring the charging voltage, and
the charger IC is configured to:
control the charging current and the charging voltage to perform a constant current charging and a constant voltage charging when the temperature of the AC power supply is below a first temperature, and
reduces the charging current being currently used during the constant current charging or the constant voltage charging when the temperature of the AC power supply exceeds the first temperature while the battery is being charged using the constant current charging or the constant voltage charging.

5. The electronic device of claim 1, wherein when the temperature of the AC power supply is reduced to below the first temperature or below a second temperature lower than the first temperature, the charger IC is configured to stop the control for reducing the charging current and return the charging current to an original value.

6. A system comprising an electronic device and an AC power supply removably mounted in an AC power supply mounting portion of the electronic device, the electronic device comprising:
a battery;
a power supply circuit configured to supply power to components in the electronic device by using DC power from an AC power supply or DC power from the battery; and
a charging circuit configured to charge the battery by using the DC power from the AC power supply, the charging circuit including a charger IC configured to control a charging current and a charging voltage which are output from the charging circuit to the battery,
wherein the charger IC includes a first input terminal for monitoring a temperature of the AC power supply, and is configured to perform control for reducing the charging current when the temperature of the AC power supply exceeds a first temperature during the charging of the battery.

7. The system of claim 6, wherein the first input terminal of the charger IC is connected to the AC power supply through the AC power supply mounting portion to receive a signal representing the temperature of the AC power supply from the AC power supply.

8. The system of claim 6, wherein the charger IC is configured to:
enable the control for reducing the charging current when the AC power supply is mounted in the AC power supply mounting portion of the electronic device, and
disable the control for reducing the charging current when the AC power supply is connected to a DC power input terminal of the electronic device through a power cable.
